(19) United States
(12) Patent Application Publication
(10) Pub. No.: US 2013/0038207 A1
(43) Pub. Date: Feb. 14, 2013

(54) MERCURY-FREE HIGH INTENSITY GAS-DISCHARGE LAMP

(71) Applicants: Michael Haacke, Aachen (DE); Timo Borlet, Echt (NL)

(72) Inventors: Michael Haacke, Aachen (DE); Timo Borlet, Echt (NL)

(73) Assignee: KONINKLIJKE PHILIPS ELECTRONICS N.V., EINDHOVEN (NL)

(21) Appl. No.: 13/642,174

(22) PCT Filed: Apr. 12, 2011
(86) PCT No.: PCT/IB2011/051563

§ 371 Date: Oct. 23, 2012

(30) Foreign Application Priority Data
Apr. 22, 2010 (EP) 10160721.6

(51) Int. Cl. H01J 61/18; H01J 61/073; H01J 61/82; H01J 61/30

(52) U.S. Cl. 313/620; 313/638; 313/634; 313/631

(57) ABSTRACT

The invention describes a mercury-free high-intensity gas-discharge lamp (1) comprising a discharge vessel (5) enclosing a fill gas in a discharge chamber (2) and comprising a pair of electrodes (3, 4) extending into the discharge chamber (2), for which lamp (1) the fill gas is derived from a salt fill introduced into the discharge chamber (2) prior to sealing, which salt fill is free of scandium and includes a halide composition comprising a sodium halide to a proportion of at least 65 wt % and at most 97.2 wt %,a thallium halide to a proportion of at least 2 wt % and at most 25 wt %, and an indium halide to a proportion of at least 0.5 wt % and at most 25 wt %. Eliminating the highly reactive scandium from the fill gas significantly improves lumen maintenance.

### FIELD OF THE INVENTION

The invention describes a mercury-free high intensity gas-discharge lamp.

### BACKGROUND OF THE INVENTION

In a high-intensity discharge (HID) lamp, an electric arc established between two electrodes produces an intensely bright light. When used in automotive headlamp applications, HID lamps have a number of advantages over other types of lamp. For instance, the light output of a metal halide xenon lamp is greater than that of a comparable tungsten-halogen lamp. Also, HID lamps have a significantly longer lifetime than filament lamps. These and other advantages make HID lamps particularly suited for automotive headlamp applications.

In prior art HID lamps, a discharge chamber contains a fill gas comprising mostly xenon, a combination of halides and one or more other metal salts that vaporise during operation of the lamp. Older HID lamps included mercury in the fill gas. For obvious health and environmental reasons, the use of mercury in such lamps is being phased out. Conventional automotive HID lamps generally include a transition metal halide (also referred to as a rare-earth halide) such as scandium iodide (ScI3) in order to obtain the required light output.

The quality of the light output by an automotive lamp is crucial for safety. Firstly, the headlamps of a vehicle must sufficiently illuminate the road for the driver of that vehicle. Secondly, other participants in road traffic should not be subject to potentially dangerous glare from the headlamps of other vehicles. Equally, the light output by a vehicle's headlamps should be of such good quality that the vehicle can be immediately recognised by other traffic participants. To ensure that vehicle headlamps satisfy certain minimum criteria, characteristics of automotive lamps such as colour, operational voltage, lamp driver characteristics, dimensions, etc., are specified in different countries by the appropriate regulations, for example by ECE-R99 in Europe, where ‘ECE’ stands for ‘Economic Commission for Europe’. Often, the lamps specified in these regulations are simply referred to by their designation, e.g. a ‘D2 lamp’ is understood to mean a 35 W burner containing mercury, a ‘D4 lamp’ is understood to mean a 35 W mercury-free burner, etc.

An HID lamp eventually deteriorates due to various factors such as chemical reactions between the aggressive salt filling (e.g. scandium iodide) and the quartz vessel. This leads to crystallisation of the arc tube, which takes on a milky white appearance and becomes opaque. R-type lamps (e.g. a D4R lamp) with a pinstripe for preventing glare are particularly prone to this type of crystallisation. Since the crystallisation makes the quartz glass opaque, it has a markedly detrimental effect on the lumen maintenance of the lamp. More specifically, the lamp's beam-maintenance will be negatively affected. The ‘beam maintenance’ is used to express how the quality of the beam changes over time. Ideally, a lamp would maintain its light output or beam quality over its entire lifetime. A constant level of beam maintenance is a very desirable for safety aspects in automotive headlamp applications. In practice, as is known from the prior art lamps, with increased crystallisation of the discharge vessel (due to strong temperature driven chemical reactions), the quality of the beam deteriorates since less light is emitted from the lamp, and the emitted light may no longer be homogenously emitted since the crystallisation is generally unevenly distributed. As a result, the reach and the homogeneity of the light distribution on the road will be reduced. Ultimately, as the crystallisation damage to lamp progresses, the arc tube can overheat during operation, and can eventually fail and may even explode.

The maintenance of the beam is also adversely affected by the chemical reactions between the highly reactive salt component and the silicon dioxide of the quartz vessel. Because some of the salt (e.g. scandium) is lost due to crystallization of the discharge bulb (by the formation of scandium silicate if a scandium halide is used in the filling), the lumen output i.e. the beam quality drops significantly. Since the glare is increased as a result, the safety of the driver and other traffic participants decreases as the lamp ages.

Another problem associated with conventional HID lamps is the increase in lamp voltage as the lamp ages. This is due to the formation of free halogens (e.g. iodine or bromine) released from their metal salt as the lamp ages. Initially, a relatively low voltage is sufficient to start the lamp, but, as the lamp ages and the amount of free halogen in the fill gas increases, the voltage required to ignite and maintain the arc eventually exceeds the voltage than can be provided by the lamp's ballast.

U.S. Pat. No. 6,392,346 describes a 400 W scandium-free lamp, in which scandium iodide is replaced by other rare-earth iodides to obtain a particular colour-rendering behaviour. However, the light output by a lamp is governed by many factors. Lamps with similar fillings but different geometries also behave very differently. Therefore, the approach taken by U.S. Pat. No. 6,392,346 is not applicable to HID lamps of lower rated power, such as lamps for automotive headlamp applications.

Therefore, it is an object of the invention to provide an improved HID lamp which avoids the problems mentioned above.

### SUMMARY OF THE INVENTION

This object is achieved by the mercury-free high-intensity gas-discharge lamp according to claim 1.

The mercury-free high-intensity gas-discharge lamp according to the invention comprises a discharge vessel enclosing a fill gas in a discharge chamber and a pair of electrodes extending into the discharge chamber. The fill gas for the lamp is derived from a salt fill introduced into the discharge chamber prior to sealing, which salt fill is free of scandium and includes a halide composition comprising a sodium halide to a proportion of at least 65 wt % and at most 97.2 wt %; a thallium halide to a proportion of at least 2 wt % and at most 25 wt %, and an indium halide to a proportion of at least 0.5 wt % and at most 25 wt %.

An obvious advantage of the lamp according to the invention is that the lumen maintenance, and in particular the beam maintenance, is significantly improved. Experimental results using the lamp according to the invention have shown lumen maintenance up to 100% even after 2500 hours of operation. In other words, even well into the lifetime of the lamp, its beam is hardly subject to any deterioration in quality, so that the light output by a lamp according to the invention compares very favourably with prior art lamps, whose beam quality deteriorates markedly with lamp age. The reason for the improved beam maintenance is significant reduction in crystallization of the discharge vessel as the lamp ages. This improvement is obtained by eliminating the highly reactive and aggressive scandium from the fill gas and by using an alternative salt fill instead.

Furthermore, by using the proposed filling, the undesirable increase of lamp voltage over the lifetime of the lamp can be reduced by as much as 25%. This is because the formation of free halogen is significantly reduced in the proposed lamp filling.

Advantageously, the lamp according to the invention can be used in place of a prior art 35 W D3 or D4 headlamp without having to replace any existing electronics or fittings, so that the customer requirements mentioned in the introduction can be met. The lamp according to the invention can also be used for a rated power of 20-30 W.

The dependent claims and the subsequent description disclose particularly advantageous embodiments and features of the invention.

The ‘salt fill’ is to be understood to be the solid material introduced into the discharge chamber before being sealed by pinching, as will be known to the skilled person. This solid material can comprise pellets of various metal salts or halides. The metal salts used for the salt fill can comprise any suitable halides such as iodides or bromides. The inclusion of bromides can have a positive effect on the halogen cycle. However, bromides are relatively aggressive compared to iodides. Therefore, preferably, the greater proportion of the salt fill is made up of iodides and only a small proportion is made up of bromides. In the following, therefore, but without restricting the invention in any way, the term ‘iodide’ may be used in a general manner when referring to a halide but should not be interpreted to exclude the use of other halides.

In a gas-discharge lamp, a sodium halide such as sodium iodide is a very good emitter of photons when activated with a halide of thallium such as thallium iodide. A significantly higher proportion of the sodium halide may however result in light with an orange or yellow tinge. Preferably, therefore, the halide composition comprises a sodium halide to a proportion of at least 72 wt % and at most 80 wt %, and a thallium halide to a proportion of at least 10 wt % and at most 20 wt %.

An indium halide such as indium iodide or indium bromide is included in the lamp according to the invention to adjust the chromaticity of the light as well as to adjust the flux and to influence the lamp voltage. Therefore, in a preferred embodiment of the lamp according to the invention, the halide composition comprises an indium halide to a proportion of at least 5 wt % and at most 14 wt %.

An improved emitter function can be obtained by introducing judicious amount of a suitable halide. Therefore, in a further preferred embodiment of the invention, the halide composition comprises one or more halides of the group of halides comprising lutetium halide, cerium halide and yttrium halide, to a proportion of at most 15 wt %. The addition of a proportion of one or more of this group of halides has been shown to improve the efficacy of the lamp by up to 3-5%.

During operation of the lamp, oxygen and other ‘pollutants’ such as carbon monoxide or carbon dioxide can be released into the fill gas. These can act aggressively to react with the salt in the filling or with the electrodes, so that their presence in the fill gas is undesirable. Therefore, in a preferred embodiment of the invention, the halide composition comprises a gallium halide to a proportion of at most 15 wt %. For example, inclusion of gallium iodide to act as a ‘getter’ or binder to bind the potentially harmful pollutants can have a stabilising effect on the lamp chemistry.

The lamp voltage and light generation in a mercury-free HID lamp can be controlled by the inclusion of a zinc halide, usually zinc iodide, in the filling. Therefore, in a further preferred embodiment of the invention, the halide composition also comprises a zinc halide to a proportion of at most 25 wt %. The actual amount of zinc halide can be chosen according to the desired lamp voltage and also the desired colour point or chromaticity of the light to be output by the lamp.

The lamp according to the invention is preferably realised as a 25 W D5 or D6 lamp for automotive headlamp applications. In such a lamp, the capacity of the discharge chamber is at least 15 μl and at most 23 μl, while the inner diameter of the discharge chamber can be between 2.0 mm and 2.4 mm, preferably 2.2 mm, and the outer diameter of the discharge chamber can be between 5.3 mm and 5.7 mm, preferably 5.5 mm. In such a lamp, the halide composition in the fill gas of the lamp preferably has a combined weight of at least 50 μg and at most 450 μg, preferably a combined weight of between 100 μg and 300 μg. Even for this lamp with this relatively lower nominal power of 25 W, a very favourable colour temperature close to the black-body line can be achieved having a colour impression comparable to a D4 lamp and therefore satisfying the reglement for automotive headlamps.

For automotive headlight applications to date, D3 or D4 lamps rated at 35 W are widely used at present. Therefore, in a further embodiment of the invention, the lamp is realised as D3 or D4 lamp with a rated or nominal power of 35 W. In this case, the physical construction characteristics of the lamp are preferably such that the capacity of the discharge chamber of the lamp is at least 17 μl and at most 25 μl, while the inner diameter of the discharge chamber can be between 2.1 mm and 2.5 mm, preferably 2.4 mm, and the outer diameter of the discharge chamber can be between 5.9 mm and 6.3 mm, preferably 6.1 mm. In such a lamp, the halide composition in the fill gas of the lamp preferably has a combined weight of at least 150 μg and at most 400 μg.

As is known to a person skilled in the art, the electrodes in a HID lamp of the type described here protrude from opposite sides into the discharge chamber, so that the tips of the electrodes are separated by only a very small gap in order to obtain a favourably point-shaped light source. In the lamp according to the invention, the electrode tips are preferably separated by a real distance of at least 2.95 mm and at most 3.85 mm, preferably by a real distance of 3.4 mm. The optical separation between the electrode tips, i.e. the separation as seen through the glass of the inner chamber, will appear larger than the actual separation; for example a ‘real’ electrode separation of 3.6 mm corresponds to an optical separation of 4.2 mm in keeping with the R99 regulation.

To obtain a stable arc using such an electrode, experiments pertaining to the lamp according to the invention have shown that the dimensions of the electrode can play an important role. Maintenance of a stable arc depends to a large extent on the geometry of the electrodes, in particular their diameter, since the thickness of the electrodes governs the electrode temperature that is reached during operation, which in turn determines the commutation behaviour and the burn-back of the electrodes according to the ballast parameters. The diameter of the electrode for a 25 W lamp is therefore preferably at least 200 μm and at most 300 μm, more preferably at least 230 μm and at most 270 μm. For a 35 W realisation, the diameter of the electrode is preferably at least 200 μm and at most 400 μm, more preferably at least 250 μm and at most 350 μm. The electrode can be realised as a simple rod shape of uniform diameter from tip to pinch, Evidently, these dimensions apply to the initial dimensions of the electrodes before burning.

As will be known to the skilled person, the use of thorium can have a beneficial effect on the lamp performance by lowering the work function, resulting in a lower lamp temperature or a lower temperature in parts of the lamp, and less burning back of the electrodes. Therefore, in a further embodiment of the lamp according to the invention, the electrodes are preferably thoriated or thorium-doped electrodes, for example electrodes doped with up to 5% thorium oxide. Alternatively or additionally, particularly in the case of a 25 W lamp, the salt fill of the lamp can comprise up to 8-10% of a suitable thorium compound such as thorium iodide to improve the performance of the lamp, giving an overall increase in lamp efficacy of about 3-5%.

However, like mercury, thorium poses health and environmental risks. Thorium is a low-level radioactive material requiring precautions in handling so as to avoid inhalation or ingestion, and its use is also undesirable from an environmental point of view. Therefore, in a preferred embodiment of the invention, the salt fill is also free of thorium. A satisfactory lamp performance, particularly in the case of a 35 W realisation, can still be achieved with an appropriate thermal electrode design to compensate for the ‘missing’ gas-phase emitter.

The halide composition is only a small proportion of the overall gaseous content of the discharge chamber, which, for a HID lamp, is usually mostly an inert gas. Preferably, the fill gas comprises xenon gas under a pressure of at least 10 bar and at most 20 bar, preferably 13-17 bar, in a non-operational state. This is referred to as the ‘cold pressure’ of the lamp. Xenon is a preferred choice for automotive HID lamps since it can be used to obtain light of a suitable pale white shade.

The colour of an automotive headlight must comply with certain standards in order to ensure uniformity and therefore also to promote safety for drivers. One such standard is the SAE system, which was developed by the Society of Automotive Engineers in the USA to define the colours for automotive headlights, and which will be known to a person skilled in the art. Such colour characteristics of automotive headlights improve recognition in the dark, therefore increasing safety in night-time driving. This is because, even at the same intensity, light with a higher colour temperature—for example blueish-white light—is perceived by the human eye to be brighter than light with a lower colour temperature, for example light with a yellow hue. The colour temperature of a HID lamp is influenced by many factors such as lamp geometry, electrode design, fill gas composition, etc. Therefore, in a preferred embodiment of the invention, the construction parameters of the lamp and the composition of the fill gas are chosen such that a colour temperature in the range of 3000 K to 7000 K, preferably 3500 to 6000 K, is attained by the lamp during operation.

Other objects and features of the present invention will become apparent from the following detailed descriptions considered in conjunction with the accompanying drawings. It is to be understood, however, that the drawings are designed solely for the purposes of illustration and not as a definition of the limits of the invention.

### BRIEF DESCRIPTION OF THE DRAWINGS

FIG. 1 shows a cross section of a gas-discharge lamp according to an embodiment of the invention;

FIG. 2 shows a first table of experimental results using a number of embodiments of the lamp according to the invention;

FIG. 3 shows a second table of experimental results using a number of embodiments of the lamp according to the invention;

FIG. 4 shows a set of box-plots of experimental results using a number of embodiments of the lamp according to the invention.

In the drawings, like numbers refer to like objects throughout. Objects in the diagrams are not necessarily drawn to scale.

### DETAILED DESCRIPTION OF THE EMBODIMENTS

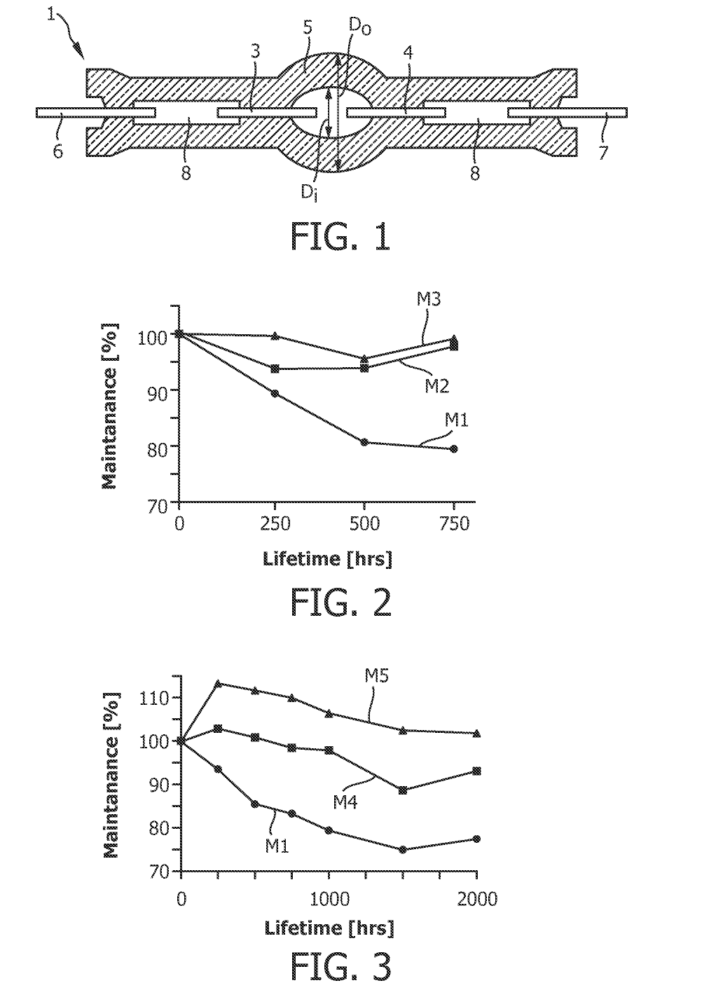

In FIG. 1, a cross section of a quartz glass high-intensity gas-discharge lamp 1 is shown according to an exemplary embodiment of the invention. Essentially, the lamp 1 comprises a quartz glass discharge vessel 5 enclosing a discharge chamber 2 containing a fill gas. Two electrodes 3, 4 protrude into the discharge chamber 2 from opposite ends of the lamp 1. During manufacturing, when the discharge vessel is still open at one end, a salt fill can be introduced, for example in the form of solid pellets of the various metal halides, as well as any other components of the filling such as the inert gas. Then, the discharge chamber 2 is sealed by pinching. The capacity (or volume) of the discharge chamber 2 is governed by the inner diameter Dᵢ and outer diameter Dₒ of the discharge vessel 5. The inner and outer diameters Dᵢ, Dₒ are measured at the widest point.

The electrodes 3, 4 can be realised as simple rods of uniform thickness from base to tip. However, the thickness of the electrodes can equally well vary over different stages of the electrodes, so that, for example, an electrode is thicker at its tip and narrower at the base. The electrodes 3, 4 are connected to external leads 6, 7 by means of molybdenum foils 8 in the pinch regions of the lamp.

For the sake of clarity, the diagram shows only the parts that are pertinent to the invention. Not shown is the base and the ballast that is required by the lamp for control of the voltage across the electrodes. When the lamp 1 is switched on, the ballast's igniter rapidly pulses an ignition voltage at several thousand volts across the electrodes 3, 4 to initiate a discharge arc. The heat of the arc vaporises the metal salts in the filling. Once the arc of high luminous intensity is established, the ballast regulates the power, so that the voltage across the electrodes 3, 4 accordingly drops to the operational level, for example, to a level between 38V and 55V for a 35 W D4 lamp.

FIG. 2 shows a first graph of experimental results showing beam maintenance (in %) against time (in hours) for a number of lamps, and a table listing the composition of the lamp fillings. A percent deviation from 100% describes an increase or decrease in light output relative to the initial light output (measured shortly after ignition) by the lamp. In this and in the following figures, the term ‘lamp’ is understood to mean a batch of lamps with the same filling composition, and it is to be understood that measurement values are averaged over a batch. The table lists only the metal of the metal halide, which can be a single halide (for example an iodide) or a combination of different halides (for example an iodide and a bromide). A first curve M1 shows the beam maintenance for a reference D4R lamp for which the salt fill comprises mainly halides of sodium and scandium. As the graph shows, the beam maintenance for the beam of light produced by this lamp drops significantly below 80% after only 750 hours of operation. The remaining curves M2, M3 show beam maintenance for two D4R lamps according to the invention. The M2 lamp comprises 87.7 wt % sodium halide, 6.4 wt % thallium halide, and 5.9 wt % indium halide. Beam maintenance for this lamp M2 after 750 hours is only slightly below 100%. Another lamp M3 comprises a halide composition comprising 81.1 wt % sodium halide, 5.9 wt % thallium halide, and 5.5 wt % indium halide as well as 0.2 wt % lutetium halide and 7.3 wt % zinc halide. The beam maintenance for this lamp M3 after 750 hours is slightly better than for the lamp M2, and is also only slightly below 100%. The initial drop in light output which is exhibited by the M2 and M3 lamps is due to the additives used for colour point correction. The colour temperature of these test lamps is around 3300 K. Initially, a drop in lumen output of around 150-200 lm is exhibited for these lamps. However, after about 500 hours, the lumen output increases again so that the beam maintenance returns towards 100%. The experiments were carried out for D4R lamps, since these are subject to more thermal stress (compared to a D4S lamp) on account of the pinstripe, which is demonstrated by the poor beam maintenance of the reference lamp M1. Even so, the beam maintenance for the D4R lamps with the salt fill according to the invention is significantly better than the reference lamp even after 500 hours of burning. The beam and lumen maintenance for D4S lamps can therefore be expected to be at least or even more favourable.

FIG. 3 shows a second graph of experimental results showing beam maintenance (in percent) against time (in hours) for a number of lamps, and a table listing the composition of the lamp fillings. A first curve M1 shows the beam maintenance for the reference D4R lamp of FIG. 2, which has an efficacy of around 80-90 lm/W. As the graph shows, after 2000 hours of operation, the beam maintenance is below 80%. The remaining curves M4, M5 show beam maintenance for two D4R lamps according to the invention having a 10-20% lower efficacy than the reference lamp. The M4 lamp comprises 97.2 wt % sodium halide, 2 wt % thallium halide, and 0.8 wt % indium halide for a salt fill with a combined weight of 200 μg. Beam maintenance for this lamp M4 after 2000 hours is about 93%. Another lamp M5, also with a halide composition comprising 97.2 wt % sodium halide, 2 wt % thallium halide, and 0.8 wt % indium halide, but with a salt fill with a combined weight of 600 μg, exhibited a beam maintenance of over 100% after 2000 hours. In other words, in spite of the lower efficacy, the performance of the lamps according to the invention actually improved over time compared to the reference lamp.

The best test batches of lamps with fillings according to the invention show a reduced initial lumen output with a drop of about 5-10%. However, after about 250 hours of operation, the lumen output increases to the initial level or even exceeds the initial level, as is the case with the M4 and M5 lamps. Increases in lumen output in excess of 100 lm have been observed experimentally. The reason for this is the significantly lower degree of crystallisation occurring in the lamp owing to the absence of scandium in the inventive filling. For example, after 500 hours, a test lamp according to the invention showed only half of the amount of ‘pinstripe’ or ‘R-type’ crystallization compared to the reference D4 lamp. This leads to the very favourable lumen maintenance of the inventive lamp.

Furthermore, in the experiments carried out, the increase in lamp voltage (associated with lamp aging) was observed to be only about 75% of the lamp voltage increase of the reference standard D4 lamp M1. Compared to the standard D4 lamp, the lamp according to the invention shows favourable luminance, flux and luminous emittance values. On average, after 15 hours of burning, the lamp according to the invention exhibited only 71% of the luminance, 92% of the flux, and 86% of the efficacy of a standard lamp. However, after 1000 hours, the lamp according to the invention exhibited 100% of the luminance, 157% of the flux, and 152% of the efficacy of a standard lamp. This very favourable behaviour over time shows that the halide composition of the lamp according to the invention offers a significant improvement compared to the prior art lamps of the same type.

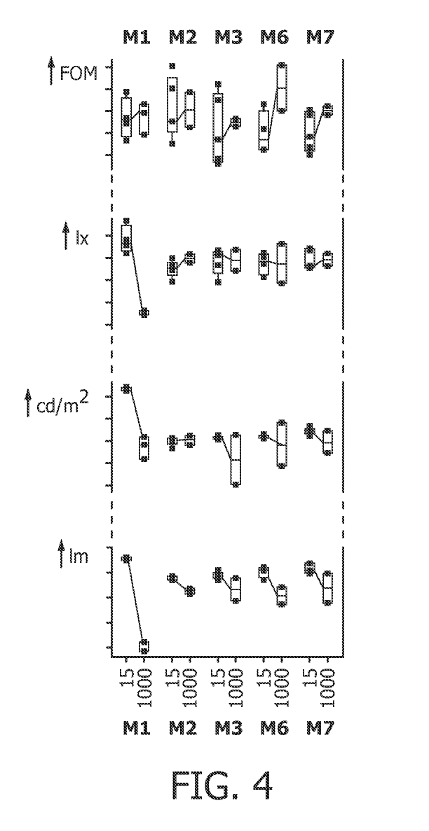

FIG. 4 shows a set of box-plots of experimental results using a number of embodiments of the lamp according to the invention and a reference lamp as above. For each lamp type, measurements were made at 15 hours and again after 2000 hours of operation. The diagram shows, from top to bottom, box-plots for figure of merit (FOM, weighted lumen measurements taken at various different points in front of the lamp), luminous emittance (lx), luminance (cd/m2) and flux (lm), with a pair of values for each lamp. In each case, the left-hand value was obtained after 5 hours of operation, and the right-hand value was obtained after 1000 hours of operation. For the reference lamp M1, values of luminous emittance, luminance and flux were significantly worse after 1000 hours. Two lamps M2, M3 with fillings as described above in FIG. 2 exhibited more favourable values after 1000 hours. Another two lamps also showed favourable results compared to the reference lamp M1. The lamp M6 had a halide composition comprising 82.7 wt % sodium halide, 11.7 wt % thallium halide, and 5.6 wt % indium halide, while the lamp M7 had a halide composition comprising 81.5 wt % sodium halide, 10 wt % thallium halide, and 3.3 wt % indium halide as well as 0.2 wt % lutetium halide and 5.1 wt % zinc halide.

Although the present invention has been disclosed in the form of preferred embodiments and variations thereon, it will be understood that numerous additional modifications and variations could be made thereto without departing from the scope of the invention.

For the sake of clarity, it is also to be understood that the use of “a” or “an” throughout this application does not exclude a plurality, and “comprising” does not exclude other steps or elements.

1. A mercury-free high-intensity gas-discharge lamp (1) comprising a discharge vessel (5) enclosing a fill gas in a discharge chamber (2) and comprising a pair of electrodes (3, 4) extending into the discharge chamber (2), for which lamp (1) the fill gas is derived from a salt fill introduced into the discharge chamber (2) prior to sealing, which salt fill is free of scandium and includes a halide composition comprising
a sodium halide to a proportion of at least 65 wt % and at most 97.2 wt %,
a thallium halide to a proportion of at least 2 wt % and at most 25 wt %, and
an indium halide to a proportion of at least 0.5 wt % and at most 25 wt %, characterized in that the halide composition has a combined weight of at most 450 μg.

2. A lamp according to claim 1, wherein the halide composition comprises a sodium halide to a proportion of at least 72 wt % and at most 80 wt %.

3. A lamp according to claim 1, wherein the halide composition comprises a thallium halide to a proportion of at least 10 wt % and at most 20 wt %.

4. A lamp according to claim 1, wherein the halide composition comprises an indium halide to a proportion of at least 5 wt % and at most 14 wt %.

5. A lamp according to claim 1, wherein the halide composition comprises one or more halide of the group of halides comprising lutetium halide, cerium halide and yttrium halide to a proportion of at most 15 wt %.

6. A lamp according to claim 1, wherein the halide composition comprises a gallium halide to a proportion of at most 15 wt %.

7. A lamp according to claim 1, wherein the halide composition comprises a zinc halide to a proportion of at most 25 wt %.

8. A lamp according to claim 1 with a nominal power of 25 W, and for which lamp (1)
the capacity of the discharge chamber (2) is greater than or equal to 15 μl and less than or equal to 23 μl;
the inner diameter of the discharge chamber (2) comprises at least 2.0 mm and at most 2.4 mm;
the outer diameter of the discharge chamber (2) comprises at least 5.3 mm and at most 5.7 mm; and
the halide composition in the fill gas of the lamp (1) has a combined weight of at least 50 μg and at most 450 μg.

9. A lamp according claim 1 with a nominal power of 35 W, and for which lamp (1)
the capacity of the discharge chamber (2) is greater than or equal to 17 μl and less than or equal to 25 μl;
the inner diameter of the discharge chamber (2) comprises at least 2.1 mm and at most 2.5 mm;
the outer diameter of the discharge chamber (2) comprises at least 5.9 mm and at most 6.3 mm; and
the halide composition in the fill gas of the lamp (1) has a combined weight of at least 150 μg and at most 400 μg.

10. A lamp according to claim 1, wherein the electrodes (3,4) are arranged at opposing ends of the discharge chamber (2) and wherein an electrode (3, 4) of the lamp (1) is a tungsten electrode (3, 4), for which electrode (3, 4) the diameter is at least 200 μm and at most 400 μm.

11. A lamp according to claim 1, wherein the tips of the electrodes (3, 4) are separated by a distance of at least 2.95 mm and at most 3.85 mm.

12. A lamp according to claim 1, wherein the salt fill is free of thorium.

13. A lamp according to claim 1, wherein an electrode (3, 4) comprises a non-thoriated electrode (3, 4).

14. A lamp according claim 1, wherein the construction parameters of the lamp (1) and the composition of the salt fill in combination with an inert gas filling are chosen such that a colour temperature in the range of 3000 K to 7000 K is attained by the lamp (1) during operation.
